(19) United States
(12) Patent Application Publication
(10) Pub. No.: US 2007/0034488 A1
(43) Pub. Date: Feb. 15, 2007

(54) Roller-type conveying machine

(76) Inventor: Tuan-Mei Chiu Chen, Ta Lin Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/199,119

(22) Filed: Aug. 9, 2005

(51) Int. Cl. B65G 13/02; B65G 13/12

(52) U.S. Cl. 198/861.1; 198/782; 198/791

(57) ABSTRACT

A conveying machine includes two opposed supporting frames, several locating members spaced apart along the supporting frames, and several conveying rollers supported on the locating members at two ends; the locating members can be relocated to adjust the distance between the conveying rollers according to the dimensions of articles to be conveyed with the conveying machine; when the conveying machine is used to convey big articles, the user is allowed to increase the distance between the conveying rollers, thus reducing the number of conveying rollers in use and power consumption.

### BACKGROUND OF THE INVENTION

1. Field of the Invention

The present invention relates to a roller-type conveying machine, more particularly one, which is equipped with rollers capable of being relocated for adjustment of distance between them according to the dimensions of the articles to be conveyed with the conveying machine; thus, the rollers and power can be used economically.

2. Brief Description of the Prior Art

A conventional conveying machine includes two opposed supporting frames, and several conveying rollers; the supporting frames have equidistantly spaced locating holes along them; the conveying rollers have chain wheels near to two ends of central shafts thereof, and the central shafts are passed through the locating holes of the supporting frames at two ends. The chain wheels are engaged with chains of an actuating mechanism such that movement of the actuating mechanism will be passed onto the conveying rollers. However, small articles are prone to fall over or fall off when being conveyed with the conveying machine because the distance between the conveying rollers is fixed; to overcome this problem, the user usually purchases a belt for use with the conveying rollers, causing increase to equipment cost. Or alternatively, the user can choose a conveying machine whose rollers are relatively closely spaced to prevent small articles from falling over in conveyance. However, the rollers of such conveying machine can't be relocated to adjust the distance between them. Consequently, when big articles are to be conveyed with the conveying machine, the user can't increase the distance between the rollers for reducing the number of used rollers and power consumption. In other words, such conveying machine isn't economical to use. In addition, many conventional conveying machines will produce loud noise in running owing to incomplete engagement between the chains and the chain wheels. And, the chains can become too loose and fall off after having been used for a long time.

### SUMMARY OF THE INVENTION

It is a main object of the present invention to provide an improvement on a roller-type conveying machine to overcome the above-mentioned problem. The conveying machine includes two opposed supporting frames, several locating members spaced apart along the supporting frames, and several conveying rollers supported on the locating members at two ends thereof. Each supporting frame has a lengthways-extending guide trench, and each locating member has through holes on an upper side; fixing elements are passed through the through holes of the locating members, and passed through and joined to slide blocks, which are held in the guide trenches, such that the locating members are secured on the supporting frames. Therefore, the locating members can be relocated to adjust the distance between the rollers. When the conveying machine is used to convey big articles, the user is allowed to increase the distance between the rollers, thus reducing the number of conveying rollers in use and power consumption.

### BRIEF DESCRIPTION OF THE DRAWINGS

The present invention will be better understood by referring to the accompanying drawings, wherein:

FIG. 1 is a partial exploded perspective view of the roller-type conveying machine in the present invention,

FIG. 2 is a side view of the conveying machine of the invention,

FIG. 3 is a front sectional view of the present invention,

FIG. 4 is a partial front sectional view of the conveying machine of the present invention,

FIG. 5 is a perspective view of the of the present invention, and

FIG. 6 is a lateral sectional view of the present invention.

### DETAILED DESCRIPTION OF THE PREFERRED EMBODIMENTS

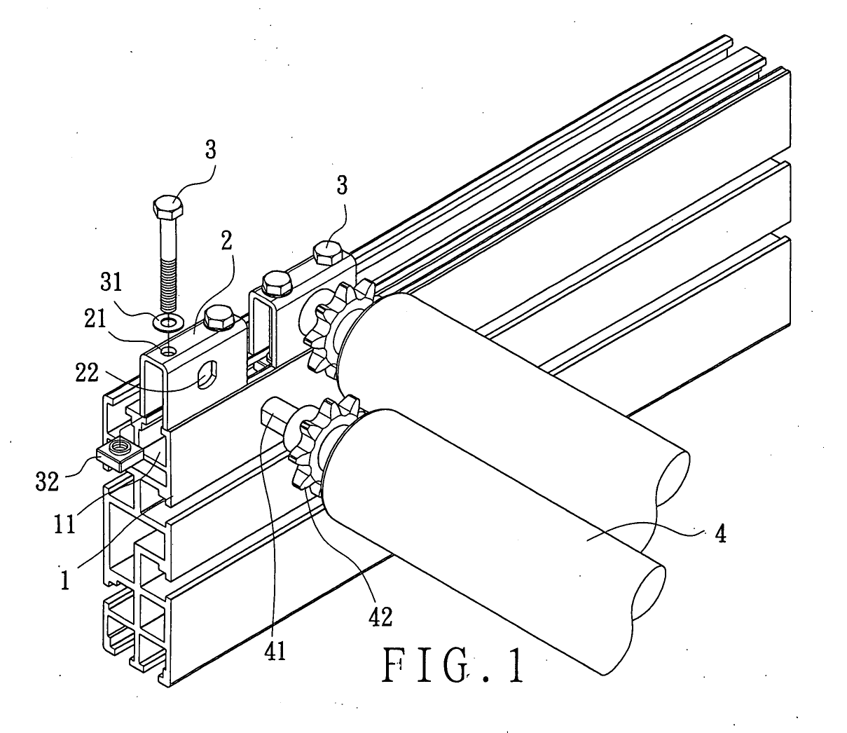

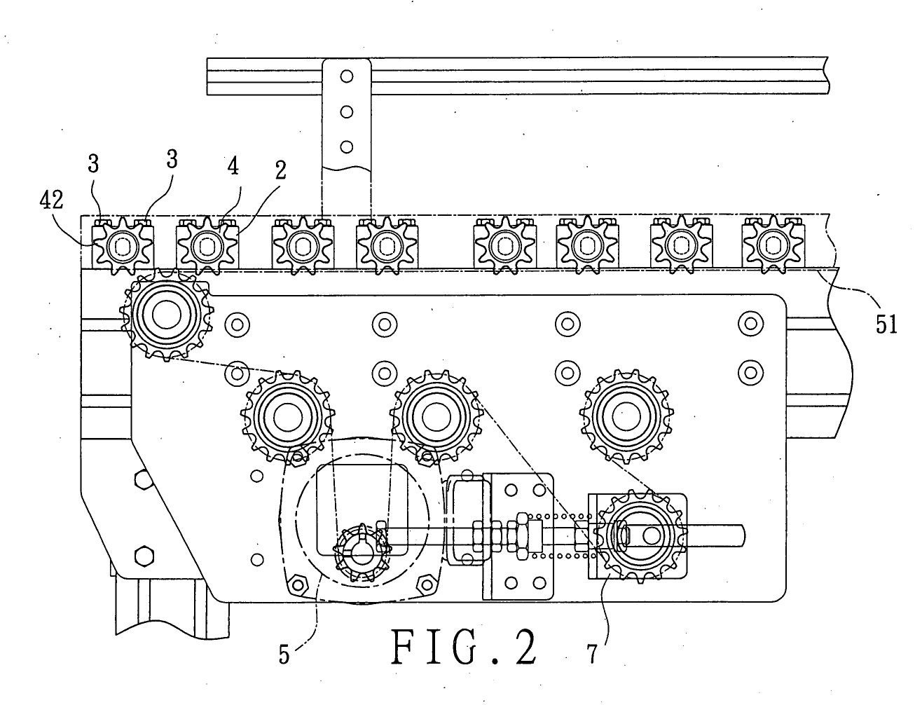

Referring to FIGS. 1 and 2, a preferred embodiment of a roller-type conveying machine includes two opposed supporting frames 1, several locating members 2, several conveying rollers 4, an actuating mechanism 5, and an adjustment device 7.

Each of the supporting frames 1 has a lengthways-extending guide trench 11 on an upper end thereof. The locating members 2 are spaced apart along the tops of the supporting frames 1. Each of the locating members 2 has two through holes 21 on an upper side, and a through hole 22 on a lateral side thereof. Fixing elements 3 are passed through respective pads 31, the through holes 21 of the locating members 2, and slide blocks 32 in sequence, and threadedly engaged with the slide blocks 32, which are held in the lengthways-extending guide trenches 11 of the supporting frames 1; thus, when the fixing elements 3 are tightened, the slide blocks 32 will be tightly pressed against inner sides of the supporting frames 1, and the locating members 2 will be secured on top of the supporting frames 1.

The conveying rollers 4 are positioned around respective central shafts 41. Chain wheels 42 are joined to two ends of each of the conveying rollers 4. The central shafts 41 are passed through the through holes 22 of the locating member 2 at two ends thereof such that they are held in position, incapable of being linearly displaced relative to the supporting frames 1. Therefore, the locating members 2 can be moved relative to the supporting frames 1 to adjust position of the conveying rollers 4 after the fixing elements 3 are loosened.

The actuating mechanism 5 includes chains 51, which are engaged with the chain wheels 42 of the conveying rollers 4. Therefore, the conveying rollers 4 will start to rotate to convey articles positioned thereon when the actuating mechanism 5 is activated.

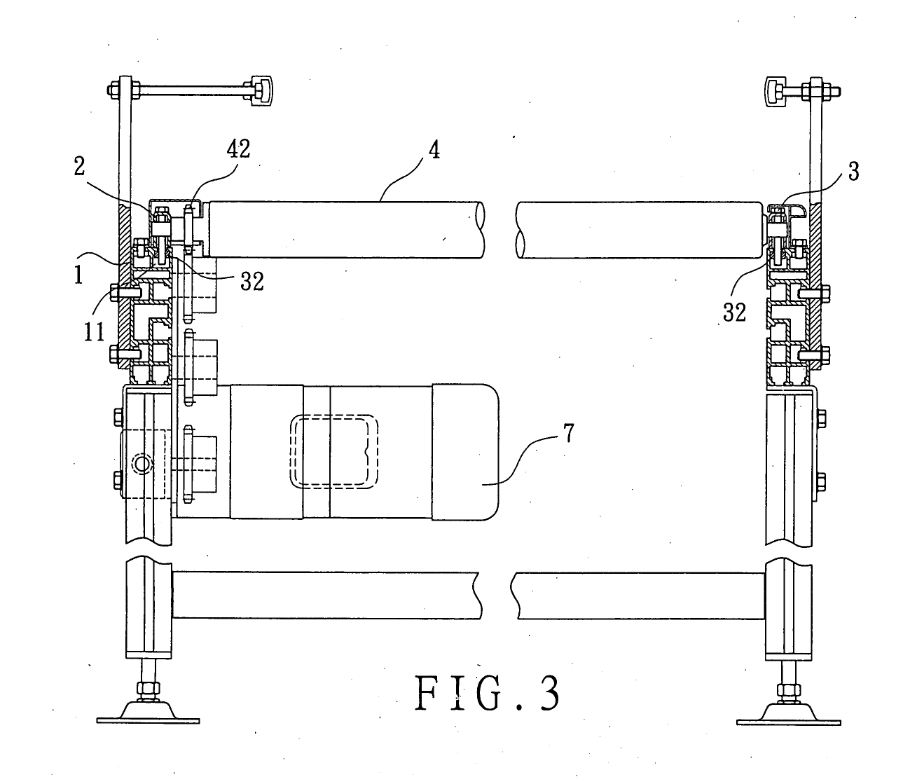

Referring to FIGS. 2 and 3, the adjustment device 7 is disposed near to lower portions of the supporting frames 1, and the chains 51 can be adjusted to a suitable tension by means of the adjustment device 7.

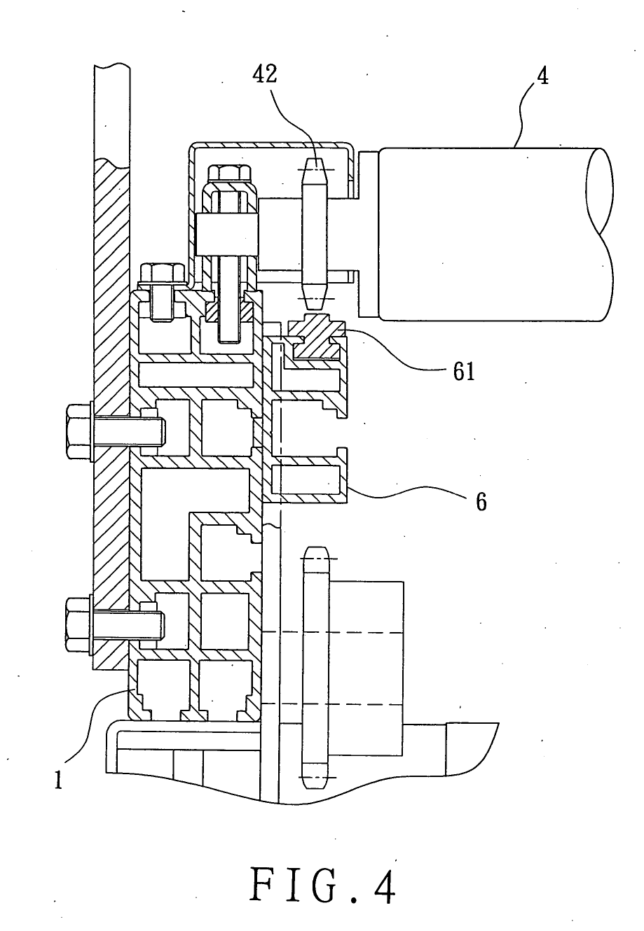

Furthermore, referring to FIG. 4, supporting seats 6 are positioned under the chain wheels 42 and secured to the supporting frames 1. And, each of the supporting seats 6 has an elongate guiding part 61 secured to the top thereof, which props a corresponding one of the chains 51 for making the chain 51 produce less noise; the elongate guiding part 61 can be made of plastics.

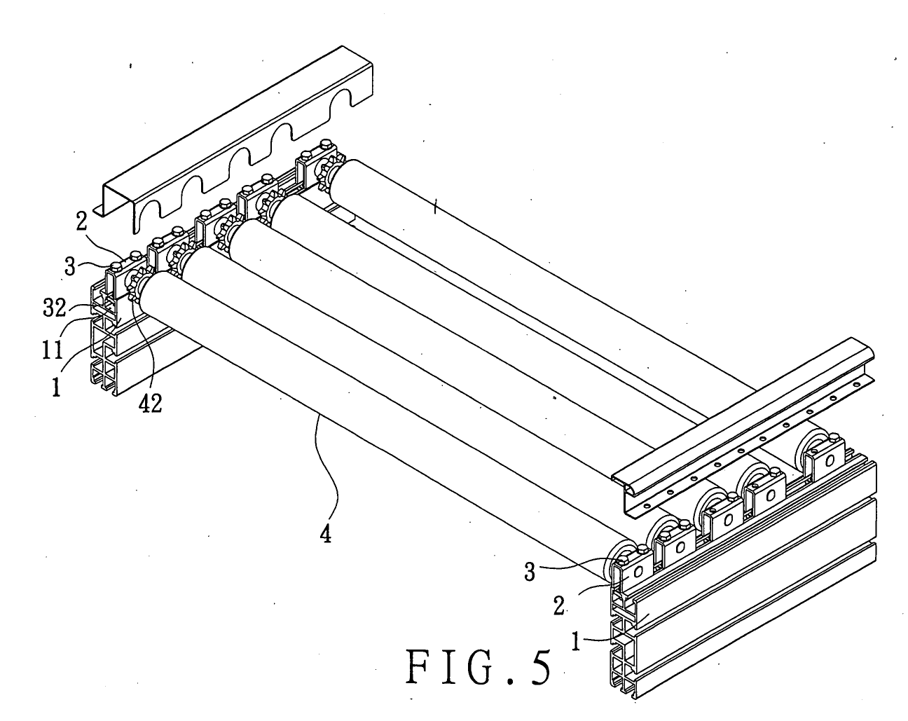

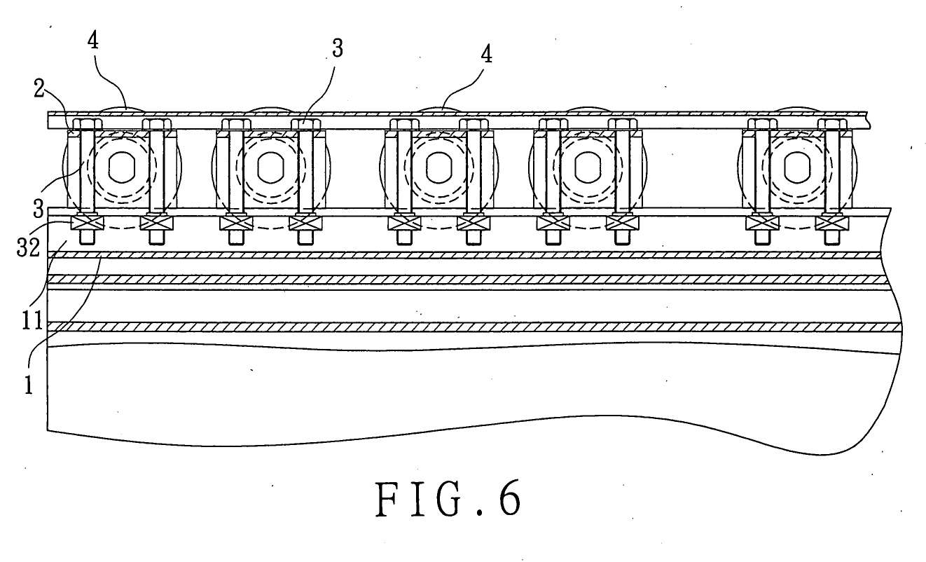

Referring to FIGS. 5 and 6, the conveying rollers 4 are relocated together with the locating members 2 according to the size of the articles to be conveyed with the present conveying machine; after the relocation, the fixing elements 3 are tightened again to secure the locating members 2 and the conveying rollers 4 in position.

From the above description, it can be easily seen that the roller-type conveying machine of the present invention has the following advantages:

1. The distance between the conveying rollers can be easily adjusted according to the dimensions of the articles to be conveyed with the present conveying machine. Therefore, the users don't have to purchase a belt for use with the conveying rollers even if small articles are to be conveyed with the conveying machine. And, when the conveying machine is used to convey big articles, the users are allowed to increase the distance between the conveying rollers, thus reducing the number of conveying rollers in use and power consumption.

2. The conveying machine has the elongate guiding parts secured to the tops of the supporting seats to prop the chains of the actuating mechanism. Therefore, the chains will engage the chain wheels properly, and produce less noise.

3. The conveying machine has the adjustment device for adjusting the chains to a suitable tension. Therefore, the chains can't become too loose or fall off the chain wheels.

What is claimed is:

1. A roller-type conveying machine, comprising
two opposed supporting frames;
a plurality of locating members spaced apart along the supporting frames; and
a plurality of conveying rollers supported on the locating members at two ends;
the locating members being capable of being relocated to adjust distance between the conveying rollers.

2. The roller-type conveying machine as claimed in claim 1, wherein each of the supporting frames has a lengthways-extending guide trench, and each of the locating members has at least one through hole on an upper side; fixing elements being passed through the through holes of the locating members, and joined to slide blocks, which are held in the lengthways-extending guide trenches, such that the locating members are secured on the supporting frames.

3. The roller-type conveying machine as claimed in claim 1, wherein the locating members have through holes on lateral sides thereof, and the conveying rollers are passed through the through holes at central shafts thereof.

4. The roller-type conveying machine as claimed in claim 3, wherein each of the conveying rollers has chain wheels near to two ends of the central shaft, and an actuating mechanism is provided, which has chains engaged with the chain wheels such that movement of the actuating mechanism will be passed on to the conveying rollers.

5. The roller-type conveying machine as claimed in claim 4 further having supporting seats positioned under the chains and secured to the supporting frames; each of the supporting seats having an elongate guiding part secured to a top thereof for propping a corresponding one of the chains of the actuating mechanism.

6. The roller-type conveying machine as claimed in claim 5, wherein the elongate guiding parts are made of plastics.
